(19) United States
(12) Patent Application Publication
(10) Pub. No.: US 2012/0092106 A1
(43) Pub. Date: Apr. 19, 2012

(54) COMPOSITE MAGNETIC BODY AND METHOD FOR PRODUCING THE SAME

(75) Inventors: Takeshi Takahashi, Kyoto (JP); Nobuya Matsutani, Osaka (JP)

(73) Assignee: PANASONIC CORPORATION, Osaka (JP)

(21) Appl. No.: 13/380,090

(22) PCT Filed: Jul. 30, 2010
(86) PCT No.: PCT/JP2010/004832

§ 371 Date: Dec. 22, 2011

(30) Foreign Application Priority Data
Aug. 4, 2009 (JP) 2009-181405

(51) Int. Cl. H01F 7/02; B22F 3/10; B22F 1/00

(52) U.S. Cl. 335/302; 419/30

(57) ABSTRACT

A composite magnetic body is formed by pressure-molding Fe—Al—Si based magnetic metal powder having a composition not more than 5.7 wt % and not less than 8.5 wt % of Al, not more than 6.0 wt % and not less than 9.5 wt % of Si, and the balance of Fe together with an insulating binder, and heat-treating the molded powder at a temperature ranging from 600° C. to 900° C. The magnetic metal powder has a negative magnetocrystalline anisotropy constant at a room temperature, and has a positive magnetostriction constant at the room temperature. A temperature coefficient of core loss at the room temperature is negative. This composite magnetic body has improved temperature characteristics of the core-loss as well as excellent soft magnetic characteristics, such as lower loss and higher permeability.

### TECHNICAL FIELD

The present invention relates to a composite magnetic body to be used typically in inductors, choke-coils, transformers of electronic devices, and it also relates to a method for manufacturing the composite magnetic body.

### BACKGROUND ART

Electric apparatuses and electronic devices have been downsized in recent years. This market trend requires products made of magnetic body to be smaller in size and to work more efficiently. The products made of conventional magnetic body are, e.g. a ferrite core made of ferrite powder or a dust core molded of magnetic metal powder. These cores are employed in choke coils of a high-frequency circuit.

The ferrite core has a small saturation flux density and its direct-current (DC) bias characteristics are inferior. To overcome these drawbacks, the conventional ferrite core is provided with a gap of several hundreds micrometers along a direction perpendicular to the magnetic path for obtaining sufficient DC bias characteristics. Although this gap prevents the inductance from lowering when the DC is superposed, such a wide gap generates not only beat tone but also leakage flux that incurs significant copper loss in the windings particularly at a high-frequency band.

On the other hand, the dust core molded of magnetic metal powder has a significantly greater saturation flux density than the ferrite core, so that the dust core is advantageous over the ferrite core from the perspective of downsizing. Since the dust core can be used without preparing a gap, which the ferrite core needs, less beat tone and a smaller copper loss incurred by the leakage flux can be expected.

However, the dust core is not superior to the ferrite core in permeability and core-loss. The dust core used in a choke coil or an inductor among others encounters a greater temperature rise due to a greater core-loss, so that it is difficult to downsize this dust core. The dust core needs a greater molding density in order to improve the magnetic characteristics, so that a molding pressure of at least 5 ton/cm² or sometimes at least 10 ton/cm² is required at the manufacturing site.

The core loss of the dust core generally includes hysteresis loss and eddy-current loss. Since metallic material has a low inherent resistance, an eddy-current flows to suppress a change in the magnetic field. The eddy-current loss should be thus reduced. The eddy-current loss increases in proportional to the square of the frequency and the square of the current-flow expansion of the eddy-current. In view of these natures of the eddy-current, the surface of magnetic metal powder should be covered with insulating material, so that the current-flow expansion of the eddy current can be prevented from spreading over the whole core through expanding between the particles of the magnetic powder, and the current-flow expansion can be thus limited only within the particles of the magnetic metal powder. The eddy-current loss can be thus reduced.

Regarding the hysteresis loss, on the other hand, the dust core is molded with a high pressure, which incurs a lot of stress in the magnetic body, accordingly reducing the permeability and increasing the hysteresis loss. To overcome this problem, heat treatment is provided after the molding for releasing the stress.

The dust core formed of conventional Fe—Al—Si based magnetic powder increases the core loss as a rise of temperature. To be more specific, in the case that a temperature coefficient of the core loss is positive around a room temperature, then the dust core in a transformer or a choke coil causes a temperature rise in the core due to heat generation during the operation. This temperature rise increases the core-loss, and generates greater heat. These steps are repeated, which may incur a thermal runaway.

In an actual operation, it is necessary to prevent the dust core from increasing its core loss. To achieve this goal, the temperature of dust core must fall within a certain range considering not only its self-heating but also the temperature rise caused by heat from other components in, e.g. a power supply circuit. To be more specific, it is essential that the minimum-temperature, at which the core-loss can be minimized, should be equal to or higher than 80° C.

FIG. 7 and FIG. 8 show initial permeability μi and maximum permeability μm at center composition region of sendust of Fe—Al—Si based alloy, respectively. In general, Fe—Al—Si based alloy has a permeability sharply peaking at the composition of magnetocrystalline anisotropy constant K≈0, magnetostriction constant λ≈0, at a room temperature. In other words, the permeability sharply peaks at the vicinity of the composition of 9.6 wt % of Si, 5.5 wt % of Al, and the balance of Fe. This composition is generally referred to as sendust. Various composite magnetic materials made of Fe—Al—Si based alloy powder have been proposed.

The plus/minus sign of the magnetostriction constant λ at a room temperature is controlled to improve the temperature characteristics of the core-loss. This is one of proposals to overcome the problem discussed above.

However, although the foregoing conventional technique improves the temperature characteristics of the core-loss, the improvement is not enough for a transformer or choke coil to be used in the power supply with large output power. These applications require a composite magnetic body to with a small core-loss.

### CITATION LIST

### Patent Literature

Patent Literature 1: Japanese Patented No. 4115612

### SUMMARY OF THE INVENTION

A composite magnetic body is formed by pressure-molding Fe—Al—Si based magnetic metal powder having a composition not more than 5.7 wt % and not less than 8.5 wt % of Al, not more than 6.0 wt % and not less than 9.5 wt % of Si, and the balance of Fe together with an insulating binder, and heat-treating the molded powder at a temperature ranging from 600° C. to 900° C. The magnetic metal powder has a negative magnetocrystalline anisotropy constant at a room temperature, and has a positive magnetostriction constant at the room temperature. A temperature coefficient of core loss at the room temperature is negative.

This composite magnetic body has improved temperature characteristics of the core-loss as well as excellent soft magnetic characteristics, such as lower loss and higher permeability.

### BRIEF DESCRIPTION OF THE DRAWINGS

FIG. 1A shows characteristics of a composite magnetic body in accordance with an exemplary embodiment of the present invention.

FIG. 1B shows characteristics of a composite magnetic body in accordance with the embodiment.

FIG. 1C shows characteristics of a composite magnetic body in accordance with the embodiment.

FIG. 2 is a perspective view of a molded body of the composite magnetic body in accordance with the embodiment.

FIG. 3 shows temperature characteristics of core-loss of a composite magnetic body in accordance with the embodiment.

FIG. 4 shows characteristics of a composite magnetic body in accordance with the embodiment.

FIG. 5 shows characteristics of a composite magnetic body in accordance with the embodiment.

FIG. 6 shows characteristics of a composite magnetic body in accordance with the embodiment.

FIG. 7 shows an initial permeability at a center composition of sendust of Fe—Si—Al based alloy.

FIG. 8 shows a maximum permeability of Fe—Al—Si based alloy.

### DETAIL DESCRIPTION OF PREFERRED EMBODIMENT

A composite magnetic body according to an exemplary embodiment of the present invention includes Fe—Al—Si based magnetic metal powder having magnetocrystalline anisotropy constant K with a minus sign at a room temperature and magnetostriction constant λ with a plus sign at the room temperature, and has a negative temperature coefficient of core-loss at the room temperature. The room temperature is, e.g. 25° C.

The magnetic metal powder contained in the molded composite magnetic body has a temperature coefficient of core-loss with a negative inclination at the room temperature. The magnetic powder in the molded body has a negative magnetocrystalline anisotropy constant K when a positive magnetostriction constant λ is positive at the room temperature. The sign of magnetocrystalline anisotropy constant K, in particular, affects greatly a reduction in the core-loss.

Fe—Al—Si based magnetic metal powder containing not more than 5.7 wt % and not less than 8.5 wt % of Al, not more than 6.0 wt % and not less than 9.5 wt % of Si, and the balance of Fe and inevitable impurity is mixed with insulating binder, and then, is molded by pressurizing. Then, the molded metal powder is heated at a temperature ranging from 600° C. to 900° C., thereby providing the composite magnetic body. The composite magnetic body has a negative magnetocrystalline anisotropy constant K and a positive magnetostriction constant λ at the room temperature. Since the composite magnetic body has a negative temperature coefficient of the core-loss at the room temperature, the composite magnetic body has soft magnetic characteristics with a higher permeability and a significantly lower core-loss.

The Fe—Al—Si based magnetic metal powder may preferably contain not more than 6.5 wt % and not less than 8.0 wt % of Al, not more than 6.0 wt % and not less than 9.5 wt % of Si, and the balance of Fe and inevitable impurity, being provided with large effects.

The Fe—Al—Si based magnetic metal powder may more preferably contain not more than 6.5 wt % and not less than 8.0 wt % of Al, not more than 7.5 wt % and not less than 9.5 wt % of Si, and the balance of Fe and inevitable impurity, being provided with large effects.

The composite magnetic body in accordance with the embodiment preferably has core loss minimum at a temperature not lower 80° C., hence being prevented from thermal runaway during an actual operation.

The composite magnetic body in accordance with the embodiment preferably has a coercivity of a core not greater than 160 A/m. The core loss is influenced by magnetostriction and magnetocrystalline anisotropy. This composite magnetic body controls magnetocrystalline anisotropy constant K for significantly suppressing an increase of the core loss. In other words, the increase of the core loss can be suppressed by controlling not only the magnetostriction but also the magnetocrystalline anisotropy. However, in the case that the composite magnetic body has a large internal stress, the core loss is influenced mainly by the magnetostriction, thus suppressing the effects of the magnetic body. Since the internal stress correlates to the coercivity of core, i.e. since a large internal stress produces a large coercivity, the coercivity is preferably not greater than 80 A/m.

The magnetic metal powder according to the embodiment preferably has an average particle diameter ranging from 1 μm to 100 μm. In the case that the average particle diameter is smaller than 1 μm, a molding density is lowered, accordingly lowering the permeability. On the other hand the average particle diameter greater than 100 μm incur a large eddy current loss at high frequencies. The average particle diameter ranges more preferably from 1 μm to 50 μm.

A method for manufacturing the magnetic metal powder according to the embodiment is not specifically limited, and may be atomizing methods or pulverized powders.

The shape of particles of the magnetic metal powder according to the embodiment is not specifically limited, and may be selected from, e.g. a spherical shape and a flat shape, according to applications.

The insulating binder according to the embodiment preferably remains as an oxide in the composite magnetic body after the heat treatment at a high temperature, and may be silane-based, titanium-based, chromium-based, or aluminum-based coupling agent, or silicone resin. Epoxy resin, acrylic resin, butyral resin, or phenolic resin can be added as an assistant binding agent. In order to increase its insulating property, oxides, nitrides, or minerals can be added to the insulating binder. The oxides may be aluminum oxide, titanium oxide, zirconium oxide, or magnesium oxide. The nitrides may be boron nitride, silicon nitride, or aluminum nitride. The minerals may be talc, mica, or kaoline.

A method for manufacturing the composite magnetic body in accordance with the embodiment will be described below. First, the Fe—Al—Si based magnetic metal powder containing not more than 5.7 wt % and not less than 8.5 wt % of Al, not more than 6.0 wt % and not less than 9.5 wt % of Si, and the balance of Fe is mixed with the insulating binder. The mixed material is molded by applying pressure. The molded powder is heated at a temperature raging from 600° C. to 900° C., thereby providing a composite magnetic body having negative magnetocrystalline anisotropy constant K of the magnetic metal powder at a room temperature, positive magnetostriction constant λ at the room temperature, and a negative temperature coefficient of core loss at the room temperature. The above manufacturing method reduces the eddy-current loss and lowers hysteresis loss, thus providing the composite magnetic body with excellent soft magnetism characteristics.

The mixing and dispersion method of the magnetic metal powder with the insulating binder is not specifically limited to a certain way. For instance, various mills including a rolling ball mill, planetary ball mill, or a V blender, or a planetary mixer can be used.

The method of pressure molding the powder is not specifically limited, and may be an ordinary pressure molding. The pressure preferably ranges from 5 ton/cm² to 20 ton/cm². The pressure lower than 5 ton/cm² prevents the magnetic metal powder from being filled sufficiently, hence preventing the composite magnetic body from having a high permeability. The pressure exceeding 20 ton/cm² requires a large strength of a die and increases the size of the die, and increases the size of a pressing machine accordingly. Such a large die and a large pressing machine reduce productivity, and increase cost.

The heat treatment executed after the pressure molding prevents the magnetic characteristics from degradation caused by a stress applied to and remaining in the magnetic metal powder during the pressure-molding, so that the stress can be released. The heat treatment can be executed preferably at a higher temperature; however, an excessively high temperature may cause imperfect insulation between the magnetic metal powders, and may increase the eddy-current loss adversely. The heat treatment can be preferably executed at a temperature ranging from 600 to 900° C. The heating temperature lower than 600° C. may insufficiently release the stress, hence preventing the magnetic body from having a high permeability. The heating temperature higher than 900° C. may increase adversely the eddy-current loss.

The molded body is heated preferably in a non-oxidative atmosphere in order to prevent the magnetic characteristics from degradation caused by oxidation of the magnetic metal powder. To be more specific, the non-oxidative atmosphere may be inert gas atmosphere, such as argon gas, nitrogen gas, or helium gas. A purity of the inert gas may range from 4N to 5N. The gas at this purity may contain several ppm of oxygen; however, such a small amount of oxygen does not provide remarkable oxidation, or degrade the magnetic characteristics. The gas having a purity higher than 5N can be also usable.

Before the heat treatment according to the embodiment, the molded body can be heated as another heat treatment before the heat treatment to be degreased at a temperature ranging from 200° C. to 400° C. in an oxidizing atmosphere. This degreasing process produces a thin oxide layer mainly made of aluminum and having a thickness not greater than 100 nm at the surface of the Fe—Al—Si based magnetic metal powder. This oxide layer increases the insulation between the magnetic metal powders, hence reducing the eddy-current loss.

The molded body in accordance with the embodiment is preferably dipped in an insulating impregnant. The heat treatment at a temperature higher than 600° C. incurs heat decomposition in the insulating binder, so that the binding performance can be degraded, which weakens mechanical strength of the composite magnetic body. To overcome this drawback, the composite magnetic body after the heat treatment is impregnated with the insulating impregnant for enhancing the mechanical strength as well as increasing rust preventive effect and surface resistance. A vacuum impregnation method in which the composite magnetic body is impregnated with the impregnant in a decompressed atmosphere is preferable. The vacuum impregnation allows the impregnant to enter the composite magnetic body easier than in the ambient pressure atmosphere, so that the mechanical strength can be more improved.

### Example 1

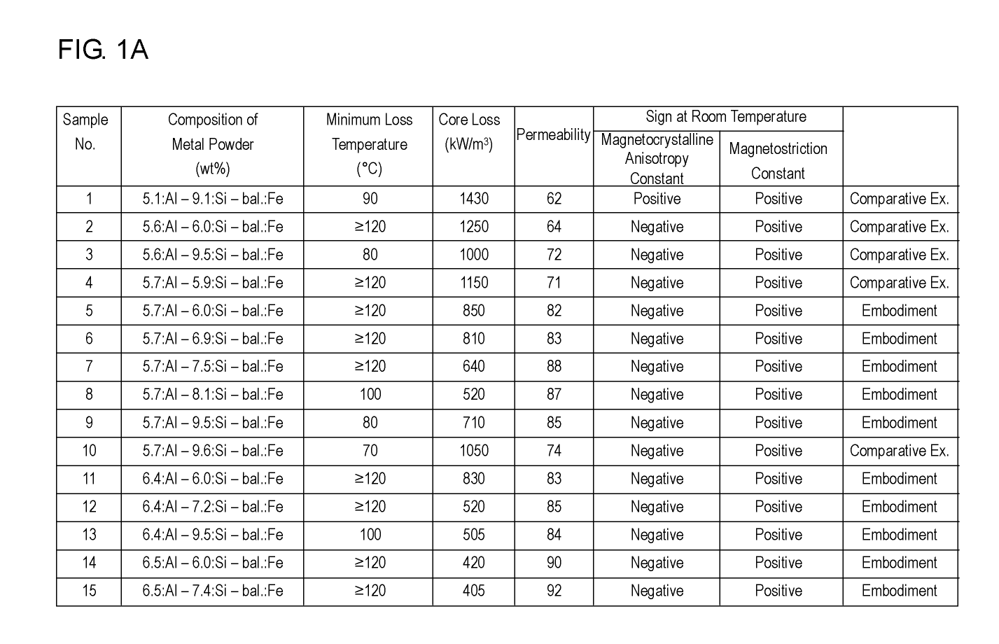

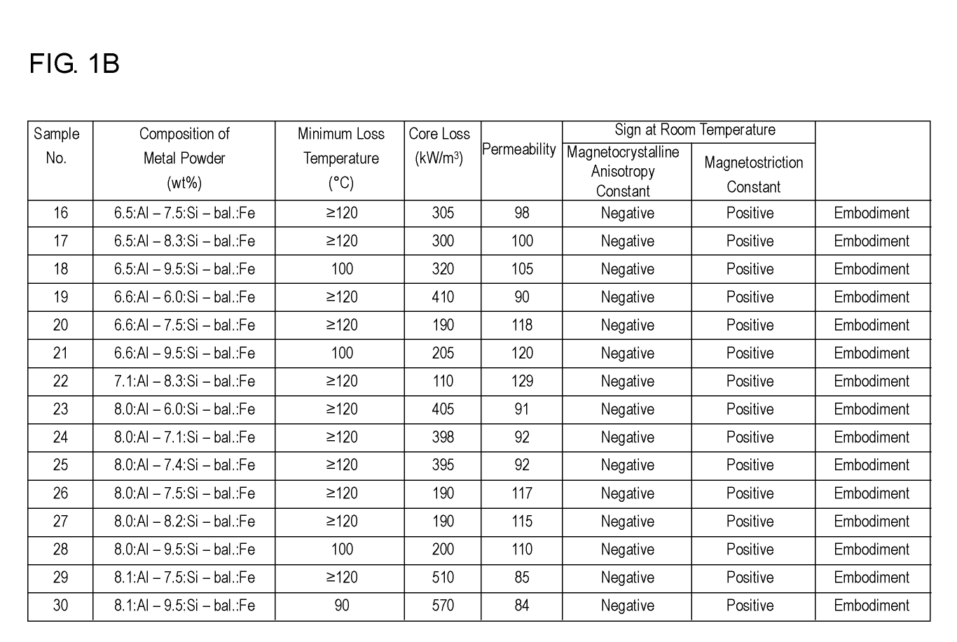

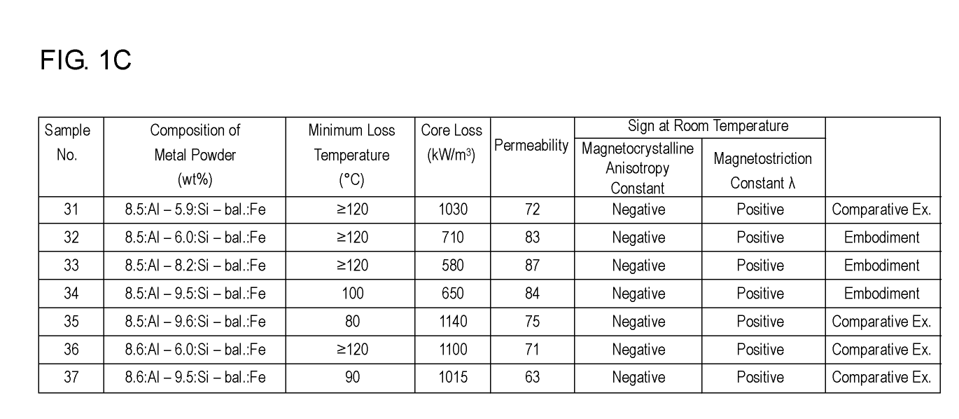

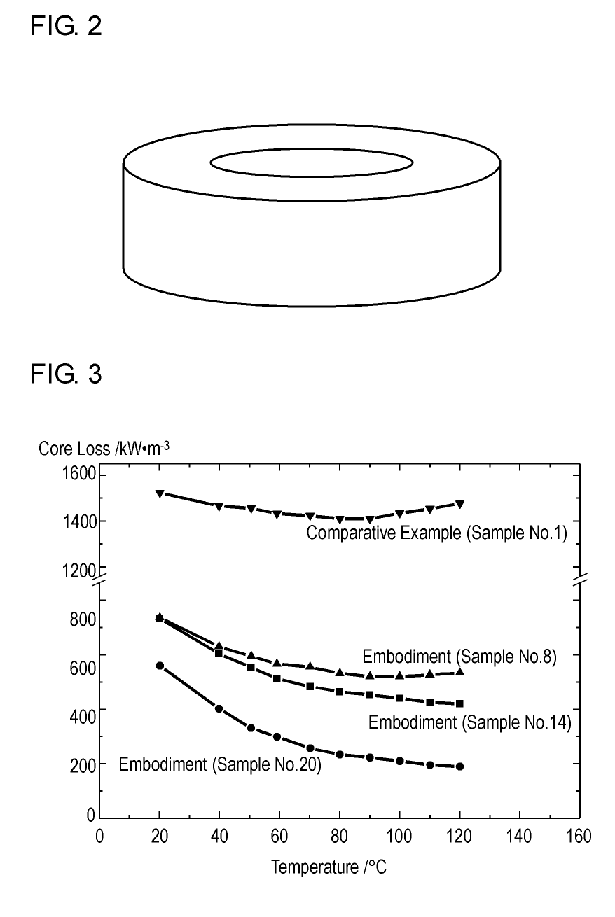

Magnetic metal powders having an average particle diameter of 15 μm and compositions described in FIGS. 1A to 1C are prepared. 1.0 part by weight of silicone resin as insulating binder and 1.0 part by weight of butyral resin as assistant binding agent are added to 100 parts by weight of the magnetic metal powder. Then, those materials are mixed into a small amount of toluene and dispersed therein for producing a compound. A pressure of 12 ton/cm² is applied to the compound for molding the compound. The molded compound is heated at a temperature of 820° C. for 60 minutes in a nitrogen gas atmosphere having purity 5N, thereby producing samples. Each sample is an annular toroidal core having an outer diameter of about 14 mm, an inner diameter of about 10 mm, and a height of about 2 mm. FIG. 2 is a perspective view of the molded body made of the composite magnetic body in accordance with the embodiment. The shape of the molded body is not limited to the annular shape, and may be a core having a different shape. FIGS. 1A to 1C shows the samples and show a core-loss, a minimum core-loss temperature at which the core-loss is smallest, a permeability, the sign of magnetocrystalline anisotropy constant K at the room temperature, and the sign of magnetostriction constant λ at the room temperature of each sample. The permeability is measured with an LCR meter at a frequency of 120 kHz. In the case that the minimum core-loss temperature is not lower than 120° C. or not higher than 20° C., the figures show the core-loss and the permeability measured at a temperature of 120° C. or 20° C., respectively.

FIG. 3 shows the temperature characteristics firstly tested of the core-loss of the samples. The core-loss is measured with an AC B-H curve measuring instrument under the condition of a frequency of 120 kHz, a flux density of 100 mT, a temperature range from 20 to 120° C. Sample No. 1 is a composite magnetic body made of magnetic metal powder having positive magnetocrystalline anisotropy constant K at the room temperature and a positive magnetostriction constant λ at the room temperature, and shown in FIG. 3 as a comparative example. Sample No. 8, an example in accordance with the embodiment, has a negative temperature coefficient of core loss at the room temperature, and has a minimum-loss temperature at which the core-loss is smallest is not lower than 80° C., so that the core-loss of sample No. 8 is smaller than that of sample No. 1 as the comparative example shown in FIG. 3. This effect remarkably appears to Sample No. 14, and more to sample No. 20. Sample No. 20 has a negative temperature coefficient of core loss, and the absolute value of the coefficient is greater than that of sample No. 8, whereby the characteristics of sample No. 20 are improved remarkably, e.g. the minimum-loss temperature exceeds 120° C., and the core-loss is 190 kW/m³.

As shown in FIGS. 1A to 1C, the magnetic metal powder has a composition containing not more than 5.7 wt % and not less than 8.5 wt % of Al, not more than 6.0 wt % and not less than 9.5 wt % of Si, and the balance of Fe provides the composite magnetic body in accordance with this embodiment with a lower core-loss, excellent temperature characteristics such as minimum-loss temperature exceeding 80° C., and a higher permeability.

Based on comparison between the group of sample Nos. 5 to 9, 11 to 13, 29, 30, and 32 to 34 and the group of sample Nos. 14 to 28, the composition containing not more than 6.5 wt % and not less than 8.0 wt % of Al, not more than 6.0 wt % and not less than 9.5 wt % of Si, and the balance of Fe is more preferable, and this composition provides a still lower core-loss as well as a still higher permeability.

Based on comparison between the group of sample Nos. 16 to 18, 20 to 22, and 26 to 28 and the group of sample Nos. 14, 15, 19, and 23 to 25, the composition containing not more than 6.5 wt % and not less than 8.0 wt % of Al, not more than 7.5 wt % and not less than 9.5 wt % of Si, and the balance of Fe is still more preferable. Based on comparison between the group of sample Nos. 16 to 18 and the group of sample Nos. 20 to 22 and 28 to 28, composition containing more than 6.6 wt % and not less than 8.0 wt % of Al, not more than 7.5 wt % and not less than 9.5 wt % of Si, and the balance of Fe is further more preferable. This composition provides a remarkably lower core-loss as well as a higher permeability.

### Example 2

Magnetic metal powder having an average particle diameter of 30 μm and a composition containing 6.7 wt % of Al, 8.4 wt % of Si, and the balance of Fe is prepared. 0.9 parts by weight of silicone resin as the insulating binder and 1.0 part by weight of acrylic resin as the assistant binding agent are added to 100 parts by weight of the magnetic metal powder. Then, those materials are mixed into a small amount of toluene, and dispersed therein for producing a compound. A pressure ranging from 5 to 15 ton/cm² is applied to the compound for molding the compound. The molded compound is heated at a temperature ranging from 500 to 820° C. for 30 to 60 minutes in a nitrogen gas atmosphere having purity 6N. Then, the compound is impregnated with epoxy resin, thereby producing samples. Each sample is an annular toroidal core having an outer diameter of about 14 mm, an inner diameter of about 10 mm, and a height of about 2 mm.

The samples are evaluated in permeability and core-loss. The permeability is measured with an LCR meter at a frequency of 100 kHz. The core loss is measured with an AC B-H curve measuring instrument under the condition of a measuring frequency of 110 kHz, a flux density of 100 mT, and a temperature range from 20 to 120° C.

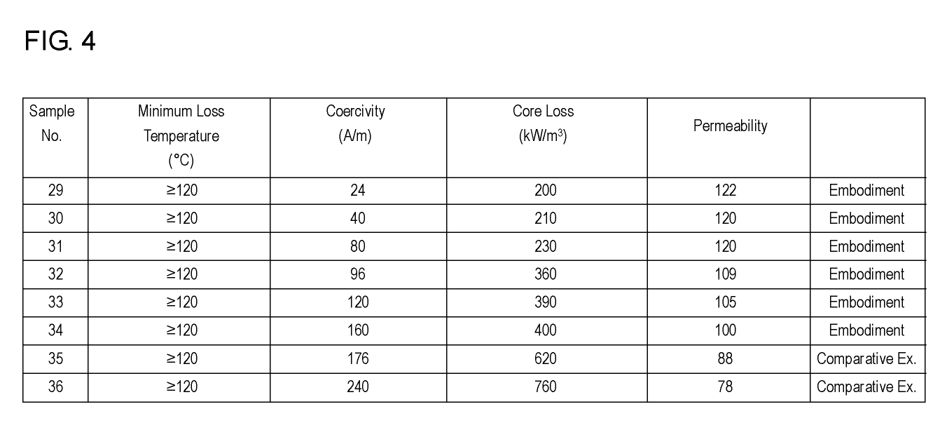

FIG. 4 shows the characteristics at the minimum-loss temperature. In the case that the minimum core-loss temperature is not lower than 120° C. or not higher than 20° C., the core-loss and the permeability measured at a temperature of 120° C. or a temperature of 20° C. are shown in the figure, respectively.

As shown in FIG. 4, the composite magnetic body in accordance with this embodiment has a lower core-loss and a higher permeability if the core has a coersivity not greater than 160 A/m. Based on comparison between the group of sample Nos. 29 to 31 and the group of sample Nos. 32 to 34, the coersivity of the core is preferably not greater than 80 A/m, hence providing the lower core-loss and the higher permeability.

### Example 3

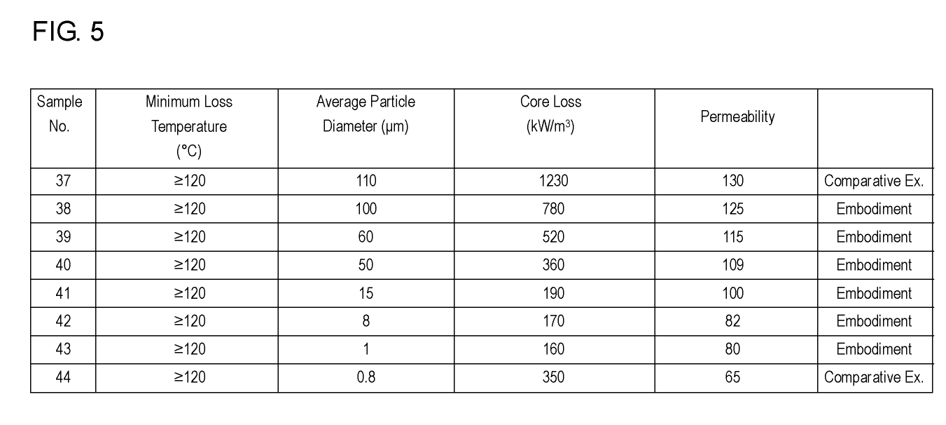

Magnetic metal powders having a composition containing 8.0 wt % of Al, 8.2 wt % of Si, and the balance of Fe and average particle diameters shown in FIG. 5 are prepared. 1.0 part by weight of silicone resin as the insulating binder and 1.0 part by weight of butyral resin as the assistant binding agent are added to 100 parts by weight of the magnetic metal powder. Then, those materials are mixed into a small amount of toluene, and dispersed therein for producing a compound. A pressure of 10 ton/cm² is applied to the compound for molding the compound. The molded compound is heated at a temperature of 350° C. for 3 hours in atmosphere for degreasing. The degreased compound is heated in a nitrogen gas atmosphere having purity 5N at a temperature of 780° C. for 30 minutes, thereby producing samples. Each sample is an annular toroidal core having an outer diameter of about 14 mm, an inner diameter of about 10 mm, and a height of about 2 mm.

The samples are evaluated in permeability and core-loss. The permeability is measured with an LCR meter at a frequency of 120 kHz. The core-loss is measured with an AC B-H curve measuring instrument under the condition of a frequency of 120 kHz, a flux density of 100 mT, and a temperature range from 20 to 120° C.

FIG. 5 shows the characteristics at the minimum-loss temperature. In the case that the minimum core-loss temperature is not lower than 120° C. or not higher than 20° C., the core-loss and the permeability measured at a temperature at 120° C. or 20° C. are shown in the figure, respectively.

As shown in FIG. 5, the magnetic metal powder having an average particle diameter ranging from 1 μm to 100 μm provides a lower core-loss and a higher permeability.

### Example 4

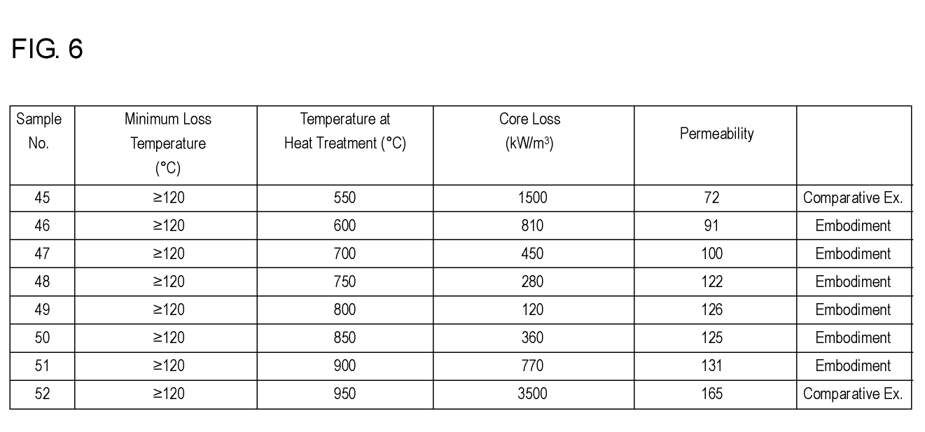

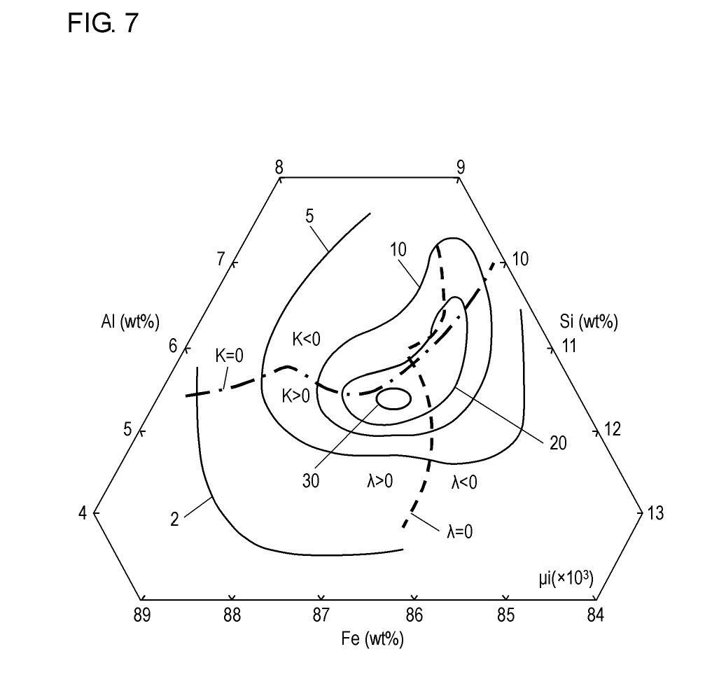

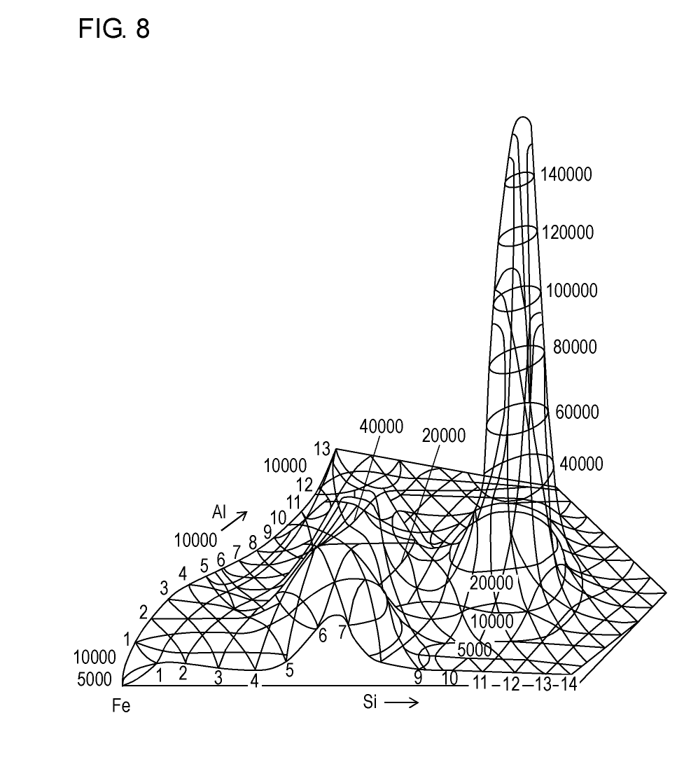

Magnetic metal powder having an average particle diameter of 20 μm and having a composition containing 7.0 wt % of Al, 8.1 wt % of Si, and the balance of Fe is prepared. 0.5 parts by weight of aluminum oxide having an average particle diameter of 0.5 μm as an insulator and 1.0 part by weight of butyral resin as binder are added to 100 parts by weight of the magnetic metal powder. Those materials are mixed into a small amount of toluene, and dispersed therein for producing a compound. A pressure of 12 ton/cm² is applied to the compound for molding the compound. The molded compound is heated at a temperature shown in FIG. 6 for 60 minutes in a nitrogen gas atmosphere having purity 6N, thereby producing samples. Each sample is an annular toroidal core having an outer diameter of about 14 mm, an inner diameter of about 10 mm, and a height of about 2 mm.

The samples are evaluated in permeability and core-loss. The permeability is measured with an LCR meter at frequency of 110 kHz. The core-loss is measured with an AC B-H curve measuring instrument under the condition of a frequency of 110 kHz, a flux density of 100 mT, and a temperature range from 20 to 120° C.

FIG. 6 shows the characteristics at the minimum-loss temperature. In the case that the minimum core-loss temperature is not lower than 120° C. or not higher than 20° C., the core-loss and the permeability measured at a temperature of 120° C. or 20° C. are shown in the figure.

As shown in FIG. 6, the heat treatment at the temperature ranging from 600° C. to 900° C. provides the composite magnetic body according to this embodiment with a lower core-loss and a higher permeability.

### INDUSTRIAL APPLICABILITY

A composite magnetic body according to the present invention improves the temperature characteristics of its core-loss, and has excellent soft magnetic characteristics, such as a lower loss and a higher permeability. The composite magnetic body is thus useful for cores of transformers, choke coils, or magnetic heads.

1. A composite magnetic body comprising
a molded body formed by pressure-molding Fe—Al—Si based magnetic metal powder having a composition not more than 5.7 wt % and not less than 8.5 wt % of Al, not more than 6.0 wt % and not less than 9.5 wt % of Si, and the balance of Fe together with an insulating binder, and heat-treating the molded powder at a temperature ranging from 600° C. to 900° C., wherein
the magnetic metal powder has a negative magnetocrystalline anisotropy constant at a room temperature,
the magnetic metal powder has a positive magnetostriction constant at the room temperature, and
the molded body has a negative temperature coefficient of core loss at the room temperature.

2. The composite magnetic body according to claim 1, wherein a minimum temperature at which the core loss is smallest is not lower than 80° C.

3. The composite magnetic body according to claim 1, wherein the magnetic metal powder contains not more than 6.5 wt % and not less than 8.0 wt % of Al, not more than 6.0 wt % and not less than 9.5 wt % of Si, and the balance of Fe.

4. The composite magnetic body according to claim 1, wherein the magnetic metal powder contains not more than 6.5 wt % and not less than 8.0 wt % of Al, not more than 7.5 wt % and not less than 9.5 wt % of Si, and the balance of Fe.

5. The composite magnetic body according to claim 1 has a coercivity not greater than 160 A/m.

6. The composite magnetic body according to claim 1, wherein the magnetic metal powder has an average particle diameter ranging from 1 μm to 100 μm.

7. A method for manufacturing composite magnetic body, the method comprising:
preparing Fe—Al—Si based magnetic metal powder containing not more than 5.7 wt % and not less than 8.5 wt % of Al, not more than 7.5 wt % and not less than 9.5 wt % of Si, and the balance of Fe;
producing a molded body by mixing the magnetic metal powder with an insulating binder, and pressure-molding the mixed powder and binder; and
providing a composite magnetic body by heating the molded body at a temperature ranging from 600° C. to 900° C., wherein
the magnetic metal powder has a negative magnetocrystalline anisotropy constant at a room temperature, and has a positive magnetostriction constant at the room temperature, and
the composite magnetic body has a negative temperature coefficient of core loss at the room temperature.
